(19) United States
(12) Patent Application Publication
(10) Pub. No.: US 2013/0141380 A1
(43) Pub. Date: Jun. 6, 2013

(54) TOUCH-SENSITIVE DEVICE AND TOUCH-SENSITIVE DISPLAY DEVICE

(71) Applicant: Wintek Corporation, Taichung City (TW)

(72) Inventors: WEN-CHUN WANG, TAICHUNG CITY (TW); MING-KUNG WU, TAI CHUNG CITY (TW); CHIA-CHI CHEN, TAI PING CITY (TW); CHIH-JUNG TENG, TAI CHUNG CITY (TW); CHIN-CHANG LIU, FENGYUAN CITY (TW); FA-CHEN WU, TAI CHUNG CITY (TW); YUNG-SHAN CHUNG, TAI CHUNG CITY (TW); PHENG-CHIH YU, MA KUNG CITY (TW); SU-MING LIN, TAI CHUNG CITY (TW); PING-WEN HUANG, TAI CHUNG CITY (TW); YU-FENG CHIEN, TAI CHUNG CITY (TW); WEI-CHIH CHEN, TAI CHUNG CITY (TW); YUAN-CHIEH HSU, TAI CHUNG CITY (TW)

(73) Assignee: Wintek Corporation, Taichung City (TW)

(21) Appl. No.: 13/756,091

(22) Filed: Jan. 31, 2013

Related U.S. Application Data
(63) Continuation-in-part of application No. 13/117,954, filed on May 27, 2011.

(30) Foreign Application Priority Data
May 18, 2011 (TW) 100117320

(51) Int. Cl. G06F 3/041

(52) U.S. Cl. CPC G06F 3/041
USPC 345/173

(57) ABSTRACT

A touch-sensitive device includes a substrate, a decorative layer, a touch-sensing structure, a media layer and an insulation layer. The decorative layer is disposed on the substrate, the touch-sensing structure is disposed on the substrate, and a part of the touch-sensing structure overlaps the decorative layer. The media layer is disposed at least between the part of the touch-sensing structure and the decorative layer, and the insulation layer is disposed on the substrate and covers the touch-sensing structure.

### CROSS-REFERENCE TO RELATED APPLICATIONS

This application is a continuation-in-part of application Ser. No. 13/117,954, filed on May 27, 2011.

### BACKGROUND OF THE INVENTION

a. Field of the Invention

The invention relates to a touch-sensitive device and a touch-sensitive display device.

b. Description of the Related Art

Referring to FIG. 1, a conventional touch panel 100 has a glass substrate 102, a silicide layer 104 formed on the glass substrate 102, a plurality of touch-sensing electrodes (such as first transparent electrodes 106a and second transparent electrodes 106b), a trace layer 108, a dielectric layer 110 and a decorative layer 112. The first transparent electrodes 106a and the second transparent electrodes 106b may be arranged in two directions perpendicular to each other. The first transparent electrodes 106a and the second transparent electrodes 106b are insulated from each other by a dielectric layer 110, and, as shown in FIG. 1, two adjacent second transparent electrodes 106b are connected with each other by a conductive pad 114. The trace layer 108 includes a plurality of metal traces, and the silicide layer 116 covers the first transparent electrodes 106a, the second transparent electrodes 106b and the trace layer 108 entirely to function as a passivation layer.

The thickness of the silicide layer 116 should be thick enough to protect the component of the touch panel 100. However, a greater thickness of the silicide layer 16 would decrease the transparency of the touch panel 100 in a touch-sensitive region and increase the fabrication costs and time. In contrast, a smaller thickness of the silicide layer 116 designed for reducing fabrication costs and time fails to effectively prevent moisture and protect metal traces, and a side edge of the touch panel 100 is liable to be scraped to reduce production yields and reliability.

### BRIEF SUMMARY OF THE INVENTION

The invention provides a touch-sensitive device having high production yields and low fabrication costs.

In order to achieve one or a portion of or all of the objects or other objects, one embodiment of the invention provides a touch-sensitive device including a substrate, a decorative layer, a touch-sensing structure, a media layer and an insulation layer. The decorative layer is disposed on the substrate, the touch-sensing structure is disposed on the substrate, and a part of the touch-sensing structure overlaps the decorative layer. The media layer is disposed at least between the part of the touch-sensing structure and the decorative layer, and the insulation layer is disposed on the substrate and covers the touch-sensing structure.

In one embodiment, the decorative layer is disposed at least on a periphery of the substrate.

In one embodiment, the touch-sensitive device further includes a trace layer disposed on the substrate and overlapping the decorative layer, and the trace layer is electrically connected to the touch-sensing structure.

In one embodiment, the touch-sensitive device further includes a first buffer layer formed on the substrate and covering the substrate, and the decorative layer is formed on the first buffer layer. Also, the touch-sensitive device may further include a second buffer layer formed between the trace layer and the decorative layer.

In one embodiment, the touch-sensitive device further includes a conductive layer disposed on the decorative layer and electrically connected to the trace layer and an external circuit.

In one embodiment, the media layer is an organic layer or a dielectric layer, and the insulation layer is made from an inorganic material or an organic material.

In one embodiment, the touch-sensing structure includes a plurality of first sensing unit and a plurality of second sensing unit, and at least one of a part of the first sensing unit and a part of the second sensing unit is formed on the decorative layer.

According to another embodiment of the invention, a touch-sensitive device includes a substrate, a decorative layer, a touch-sensing structure, a trace layer and an insulation layer. The decorative layer is disposed on the substrate, the touch-sensing structure is disposed on the substrate, and a part of the touch-sensing structure spreads over the decorative layer. The trace layer is disposed on the substrate and overlaps the decorative layer, and the trace layer is electrically connected to the touch-sensing structure. The insulation layer is disposed on the substrate and covers the touch-sensing structure and the trace layer.

According to another embodiment of the invention, a touch-sensitive device includes a substrate, a decorative layer, a touch-sensing structure, a trace layer, a buffer layer and a conductive layer. The decorative layer is disposed on the substrate, and the touch-sensing structure is disposed on the substrate. The trace layer is disposed on the substrate and overlaps the decorative layer, and the trace layer is electrically connected to the touch-sensing structure. The buffer layer is formed on the decorative layer, and a conductive layer is formed on the buffer layer and electrically connected to the trace layer. The buffer layer occupies a region overlaps the conductive layer.

According to another embodiment of the invention, a touch sensitive display device having an active display area and a non-active area includes a touch-sensitive device and a display device. The touch-sensitive device includes a substrate, a decorative layer, a touch-sensing structure and an insulation layer. The decorative layer is disposed on the substrate, the touch-sensing structure is disposed on the substrate, and a part of the touch-sensing structure spreads over the decorative layer. The insulation layer is disposed on the substrate and covers the touch-sensing structure. The display device is disposed on one side of the touch-sensitive device.

According to the above embodiments, since the second insulation layer is additionally provided in the non-touch-sensitive region, the insulating thickness for the periphery of the touch-sensitive device is considerably increased without changing fabrication processes of a touch-sensing structure in the touch-sensitive region. Moreover, the second insulation layer effectively provides moisture isolation, protects metal traces, and avoids side scrapes to improve production yields and reliability. Besides, the distribution of the second insulation layer is far smaller than that of the first insulation layer to reduce fabrication costs and time.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional schematic diagram of a conventional touch panel.

FIG. 2A shows a plan view of a touch-sensitive device according to an embodiment of the invention, and FIG. 2B shows an enlarged cross-section of FIG. 2A.

FIG. 3 shows a cross-sectional schematic diagram of a touch-sensitive device according to another embodiment of the invention.

FIG. 4 shows a cross-sectional schematic diagram of a touch-sensitive device according to another embodiment of the invention.

FIG. 5 shows a cross-sectional schematic diagram of a touch-sensitive device according to another embodiment of the invention.

FIG. 6 shows a cross-sectional schematic diagram of a touch-sensitive device according to another embodiment of the invention.

FIG. 7 shows a cross-sectional schematic diagram of a touch-sensitive device according to another embodiment of the invention.

FIG. 8 shows a cross-sectional schematic diagram of a touch-sensitive device according to another embodiment of the invention.

FIG. 9 shows a cross-sectional schematic diagram illustrating a touch-sensitive device in combination with a display device according to an embodiment of the invention.

FIG. 10A shows a partial plan view of a touch-sensitive device according to another embodiment of the invention, and FIG. 10B shows a cross-section cut along line A-A′ of FIG. 10A.

FIG. 11 shows a cross-sectional schematic diagram of a touch-sensitive device according to another embodiment of the invention.

FIG. 12 shows a plan view of a touch-sensitive device according to another embodiment of the invention.

FIG. 13 shows a plan view of a touch-sensitive device according to another embodiment of the invention.

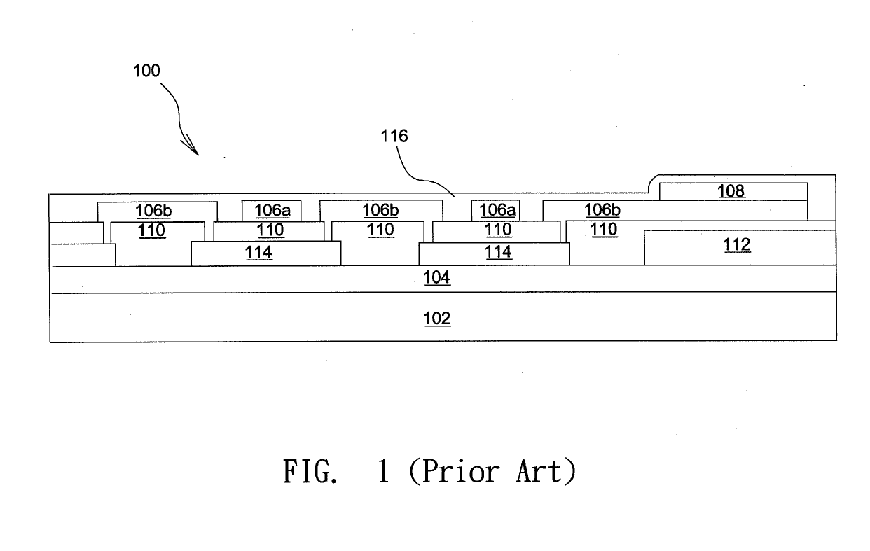

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

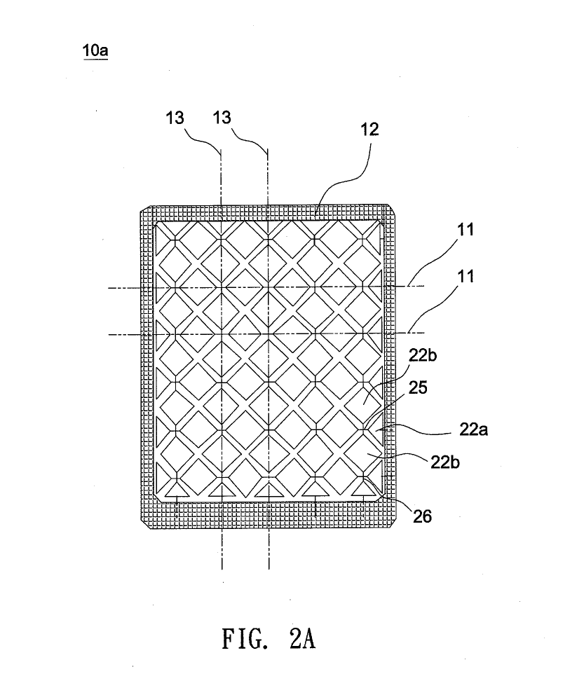

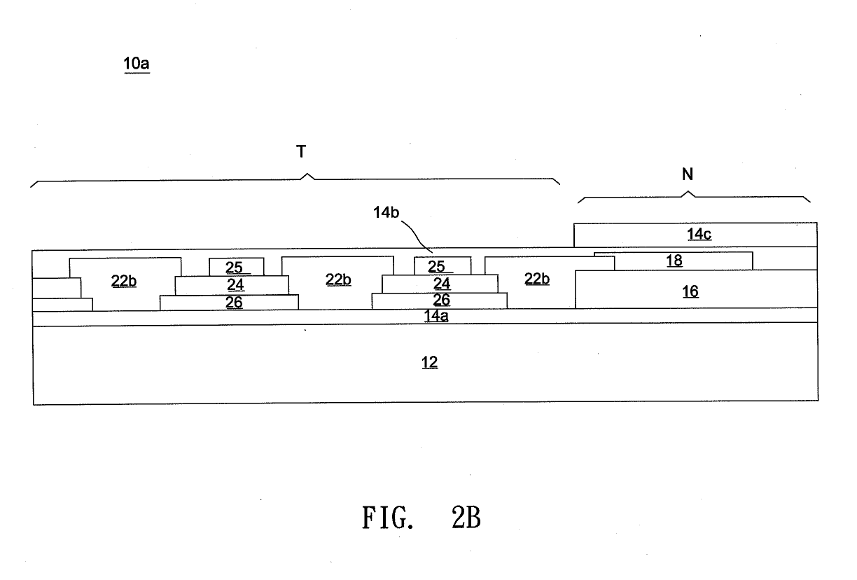

FIG. 2A shows a plan view of a touch-sensitive device according to an embodiment of the invention, and FIG. 2B shows an enlarged cross-section of FIG. 2A. As shown in FIG. 2A and FIG. 2B, a touch-sensitive device 10a includes a substrate 12 and a laminated structure formed on the substrate 12. The touch-sensitive device 10a is divided into a touch-sensitive region T and a non-touch-sensitive region N. In this embodiment, the non-touch-sensitive region N is located on the periphery of the touch-sensitive device 10a and surrounds the touch-sensitive region T. A touch-sensing structure is substantially formed in the touch-sensitive region T of the touch-sensitive device 10a to detect touch operations. The laminated structure in the non-touch-sensitive region N includes a first buffer layer 14a, a decorative layer 16 and a trace layer 18. The first buffer layer 14a may be formed on and cover the substrate 12, and the decorative layer 16 is disposed on at least one side of the substrate 12. In this embodiment, the decorative layer 16 and the trace layer 18 are disposed on the substrate 12 in succession. The material of the substrate 12 includes but not limited to glass or plastic. Further, the substrate 12 may function as a cover lens. The trace layer 18 includes a plurality of metal traces and is electrically connected to a touch-sensing structure, and the touch-sensing structure is connected to an external circuit through the metal traces. The decorative layer 16 is formed on the periphery of the substrate 12 to shield metal traces. The material of the decorative layer 16 includes diamond-like carbon, ceramic, colored ink, resin, photo resist or the combination thereof. The touch-sensing structure in the touch-sensitive region T may be a single-layer electrode structure or a multi-layer electrode structure. In the present embodiment, the touch-sensing structure may include a plurality of first sensing unit 11 and a plurality of second sensing unit 13 spaced apart from the first sensing unit 11. For example, as shown in FIG. 2B, the touch-sensing structure has an underground-island electrode structure, where each first sensing unit 11 includes multiple first transparent electrodes 22a connected with each other by multiple first connecting lines 25, each second sensing unit 13 includes multiple second transparent electrodes 22b connected with each other by multiple second connecting lines 26, and a dielectric layer 24 is disposed between the corresponding first connecting line 25 and second connecting line 26. The second connecting lines 26 are formed in a fabrication process different to the fabrication process of the first connecting lines 25, the first transparent electrodes 22a and the second transparent electrodes 22b. Besides, the second connecting lines 26 may be disposed between the dielectric layer 24 and first buffer layer 14a. Note the touch-sensing structure is not limited to an underground-island electrode structure. In an alternate embodiment, the connecting lines are connected with each other in the upper portion of the touch-sensing structure to form a bridge-island electrode structure. Further, the touch-sensing structure may be disposed on two opposite sides of the substrate 12, and the transparent electrodes may have a regular shape such as a diamond, a triangle or a line segment or may have an irregular shape.

Further, the first buffer layer 14a is an auxiliary layer used to enhance the adherence between the substrate 12 and the first transparent electrodes 22a, the second transparent electrodes 22b and the second connecting lines 26. Certainly, the first buffer layer 14a may be omitted in other embodiments. In this embodiment, the first buffer layer 14a may be made from an inorganic material such as silicon dioxide (SiO₂) or an organic material.

In this embodiment, a first insulation layer 14b covers both a touch-sensing structure in the touch-sensitive region T and a laminated structure in the non-touch-sensitive region N to protect the entire touch-sensitive device 10a. The first insulation layer 14b may be made from an inorganic material such as silicide. In this embodiment, a second insulation layer 14c is formed on the first insulation layer 14b and distributed only in the non-touch-sensitive region N, and the thickness of the second insulation layer 14c is 3-100 times greater than the thickness of the first insulation layer 14b. A distribution area of the second insulation layer 14c substantially overlaps the trace layer 18, and the thickness of the second insulation layer 14c is, in a preferred embodiment, 10-50 times greater than the thickness of the first insulation layer 14b. The second insulation layer 14c may be made from an inorganic material or an organic material. Further, in an alternate embodiment, the second insulation layer 14c may be disposed between the trace layer 18 and the decorative layer 16 or between the decorative layer 16 and the first buffer layer 14a, as long as the second insulation layer 14c is confined in the non-touch-sensitive region N.

According to the above embodiments, since the second insulation layer 14c is additionally provided in the non-touch-sensitive region N, the insulating thickness for the periphery of the touch-sensitive device 10a is considerably increased without changing fabrication processes of a touch-sensing structure in the touch-sensitive region T. Moreover, the second insulation layer 14c effectively provides moisture isolation, protects metal traces, and avoids side scrapes to improve production yields and reliability. Besides, the distribution of the second insulation layer 14c is far smaller than that of the first insulation layer 14b to reduce fabrication costs and time.

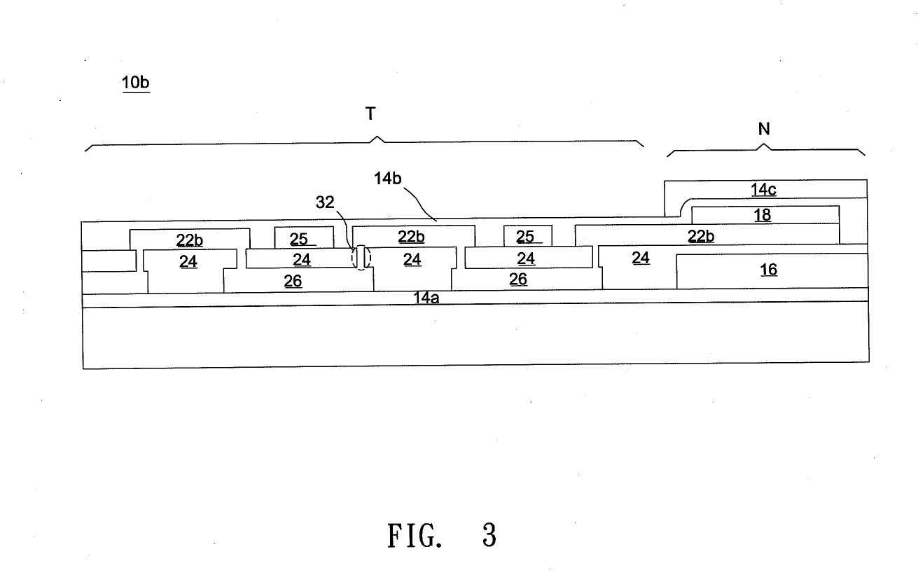

FIG. 3 shows a cross-sectional schematic diagram of a touch-sensitive device 10b according to another embodiment of the invention. Referring to FIG. 3, a laminated structure in the non-touch-sensitive region N of the touch-sensitive device 10b is similar to the laminated structure shown in FIG. 2B, but a touch-sensing structure in the touch-sensitive region T is different to the touch-sensing structure shown in FIG. 2B. The touch-sensing structure shown in FIG. 3 has an underground-via electrode structure, where each second connecting line 26 is connected to two adjacent second transparent electrodes through a via 32, and the first insulation layer 14b covers the first transparent electrodes 22a, the second transparent electrodes 22b and the first connecting lines 25.

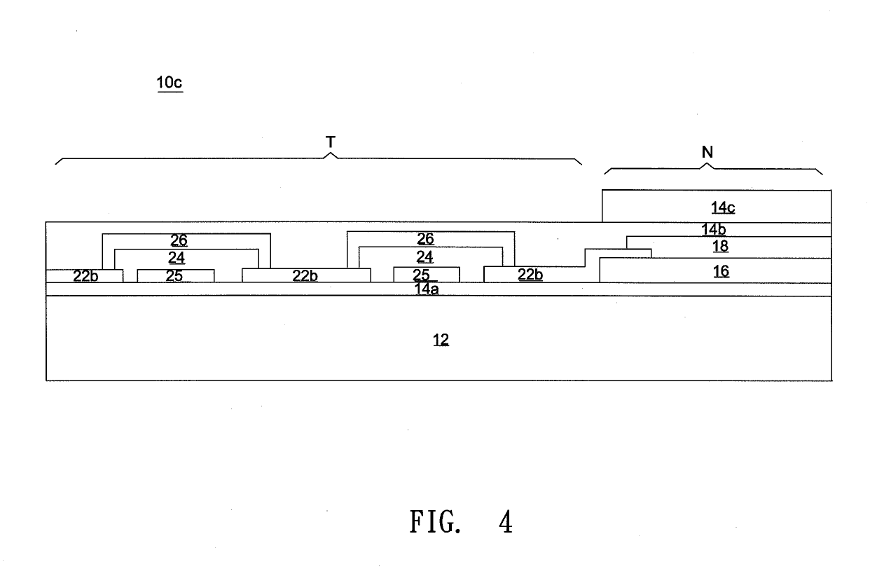

FIG. 4 shows a cross-sectional schematic diagram of a touch-sensitive device 10c according to another embodiment of the invention. Referring to FIG. 4, a laminated structure in the non-touch-sensitive region N of the touch-sensitive device 10c is similar to the laminated structure shown in FIG. 2B, but a touch-sensing structure in the touch-sensitive region T is different to the touch-sensing structure shown in FIG. 2B. The touch-sensing structure shown in FIG. 4 has a bridge-island electrode structure, where each second connecting line 26 is connected to two adjacent second transparent electrodes 22b. The first transparent electrodes 22a and the second transparent electrodes 22b are spaced apart through the dielectric layer 24, and the first insulation layer 14b covers the first transparent electrodes 22a, the second transparent electrodes 22b and the second connecting lines 26. That is, the second connecting lines 26 are disposed between the dielectric layer 24 and the first insulation layer 14b.

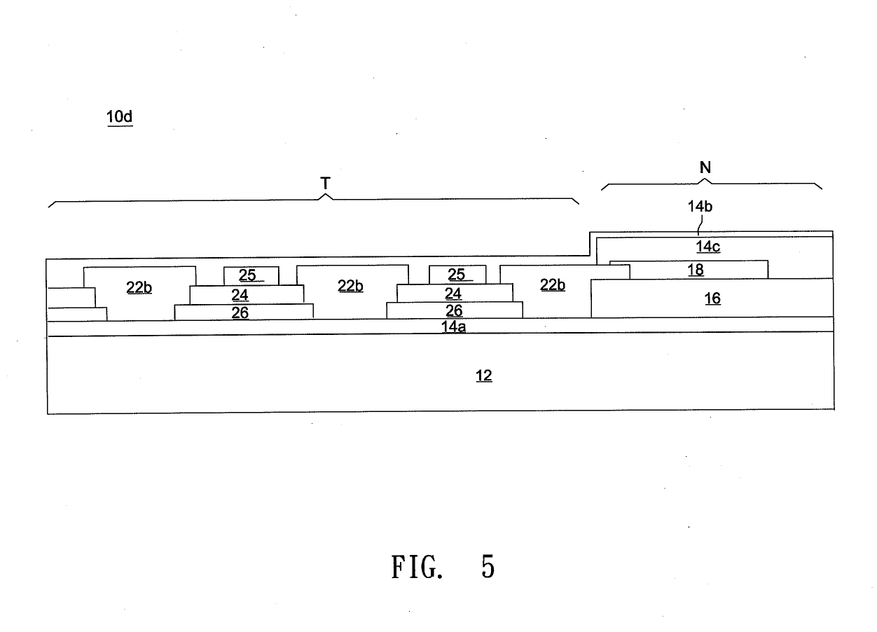

FIG. 5 shows a cross-sectional schematic diagram of a touch-sensitive device 10d according to another embodiment of the invention. Referring to FIG. 5, a touch-sensing structure in the touch-sensitive region T of the touch-sensitive device 10d is similar to the touch-sensing structure shown in FIG. 2B, but a laminated structure in the non-touch-sensitive region N of the touch-sensitive device 10d is different to the laminated structure shown in FIG. 2B. In this embodiment, the second insulation layer 14c is disposed between the trace layer 18 and the first insulation layer 14b to similarly provide moisture isolation, protect metal traces, and avoid side scrapes to improve production yields and reliability. Certainly, the arrangement that the second insulation layer 14c is disposed between the trace layer 18 and the first insulation layer 14b is also suitable for the underground-via electrode structure shown in FIG. 3 or the bridge-island electrode structure shown in FIG. 4.

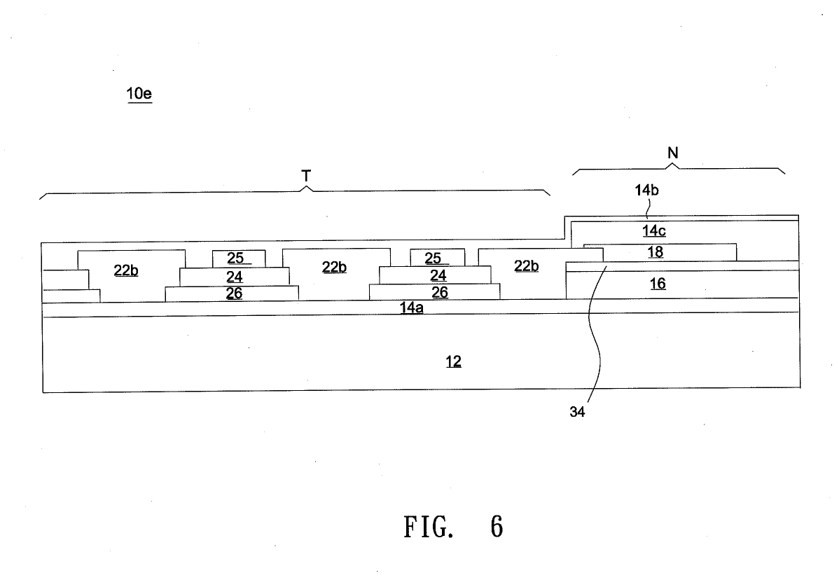

FIG. 6 shows a cross-sectional schematic diagram of a touch-sensitive device 10e according to another embodiment of the invention. Referring to FIG. 6, a touch-sensing structure in the touch-sensitive region T of the touch-sensitive device 10e is similar to the touch-sensing structure shown in FIG. 2B, but a laminated structure in the non-touch-sensitive region N of the touch-sensitive device 10e is different to the laminated structure shown in FIG. 2B. In this embodiment, a second buffer layer 34 is additionally provided between the decorative layer 16 and the trace layer 18. The second buffer layer 34 that may be made from an inorganic material such as silicon dioxide (SiO2) may enhance the connection strength between the trace layer 18 and the decorative layer 16. Certainly, the arrangement of the second buffer layer 34 is also suitable for the underground-via electrode structure shown in FIG. 3 or the bridge-island electrode structure shown in FIG. 4.

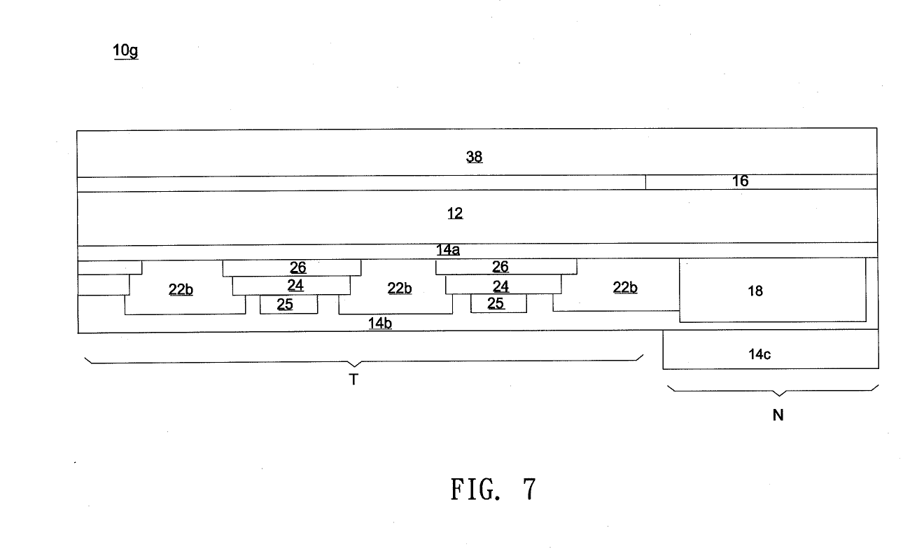

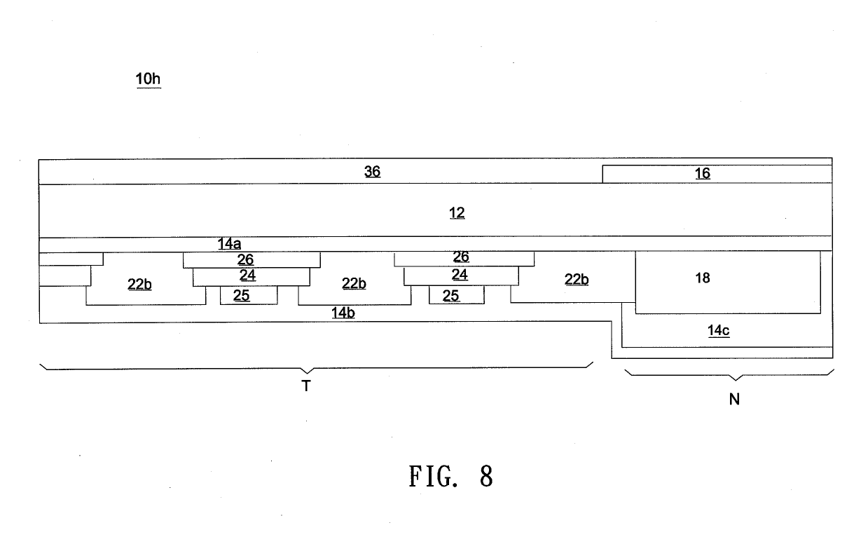

Referring to FIG. 7, a touch-sensitive device 10g includes a cover glass 38. The cover glass 38 is formed on one side of the substrate 12 opposite the trace layer 18 and has a decorative layer 16. The decorative layer 16 is formed on one side of the cover glass 38 facing the substrate 12 to allow the cover glass 38 to serve the function of shielding metal traces and protecting the entire touch-sensitive device 10g. Alternatively, as shown in FIG. 8, the cover glass 38 in a touch-sensitive device 10h may be omitted, and the decorative layer 16 is directly formed on one side of the substrate 12 opposite the trace layer 18. Further, a passivation layer 36 may be formed on the decorative layer 16 to serve protection purposes. The material of the passivation layer 36 includes but not limited to polyethylene terephthalate (PET). In addition, the second insulation layer 14c may be formed on the first insulation layer 14b (FIG. 7) or formed between the first insulation layer 14b and the trace layer 18 (FIG. 8).

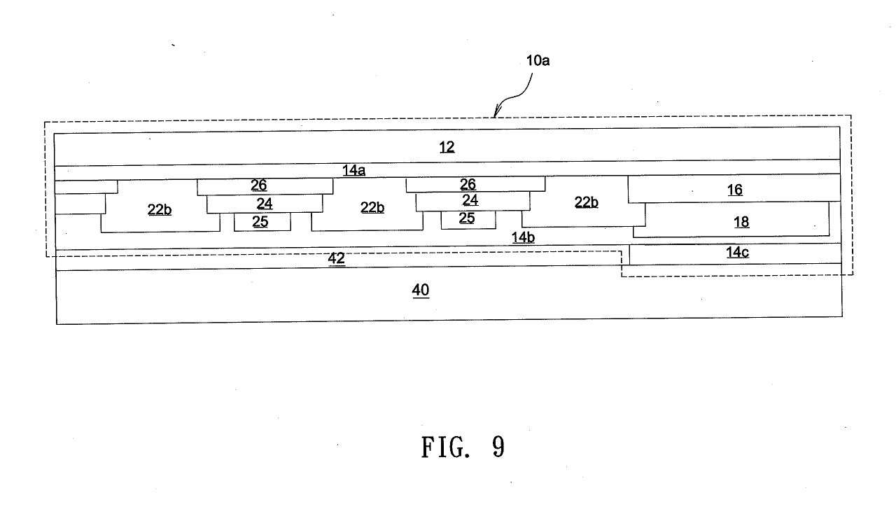

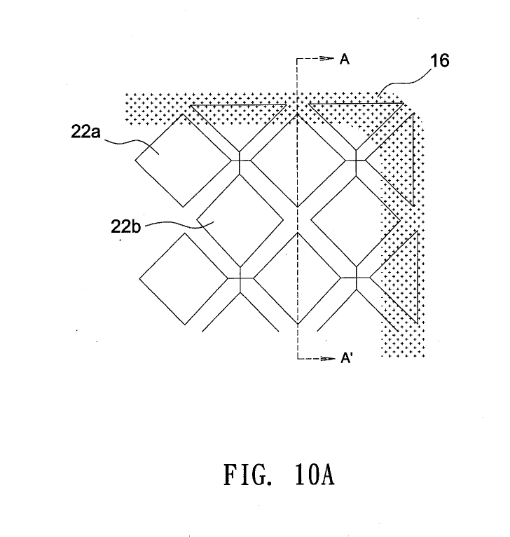

FIG. 9 shows a cross-sectional schematic diagram illustrating a touch-sensitive device in combination with a display device according to an embodiment of the invention. Referring to FIG. 9, the touch-sensitive device 10a is connected to a display device 40 by, for example, an optical adhesive 42. The type of the display device includes but not limited in a liquid crystal display, an organic light-emitting diode display, an electro-wetting display, a bi-stable display, and an electrophoretic display.

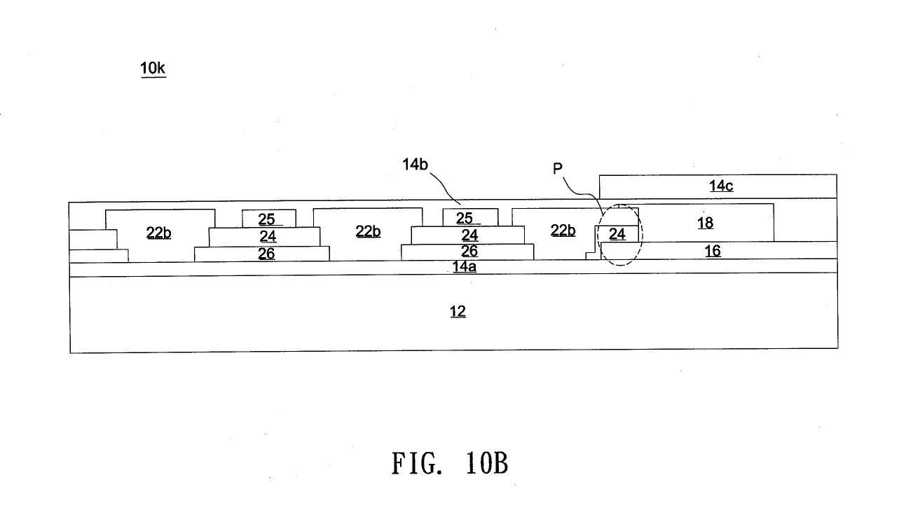

FIG. 10A shows a partial plan view of a touch-sensitive device according to another embodiment of the invention, and FIG. 10B shows a cross-section cut along line A-A′ of FIG. 10A. In this embodiment, a part of a touch-sensing structure of a touch-sensitive device 10k may extend to overlap the decorative layer 16. For example, as shown in FIG. 10A and FIG. 10B, part of the second transparent electrodes 22b may spread over the decorative layer 16. Therefore, during a formation process of the second transparent electrodes 22b, cracks may be formed in the decorative layer 16, and a transparent conductive material (such as an ITO film) that forms the second transparent electrodes 22b may be left in cracks of the decorative layer 16. Besides, since a transparent conductive material is liable to adhere to the decorative layer 16, the transparent conductive material after being etched and patterned to form a transparent electrode may leave residues on the decorative layer 16. Under the circumstance, the residues of a transparent conductive material may cause short-circuiting to result in a malfunctioned touch-sensitive device. In this embodiment, a part of the second transparent electrodes 22b overlaps the decorative layer 16 at a region P, and a media layer such as the dielectric layer 24 is disposed at least between the part of the second transparent electrodes 22b and the decorative layer 16 at the region P to shield the decorative layer 16 from the second transparent electrodes 22b. Besides, since the coating adhesion of a transparent conductive material on the dielectric layer 24 is lower than the coating adhesion of the transparent conductive material on the decorative layer 16, the transparent conductive material after being etched and patterned is not liable to leave residue on the decorative layer 16 to avoid short-circuiting and hence improve the production yield of a touch sensitive device.

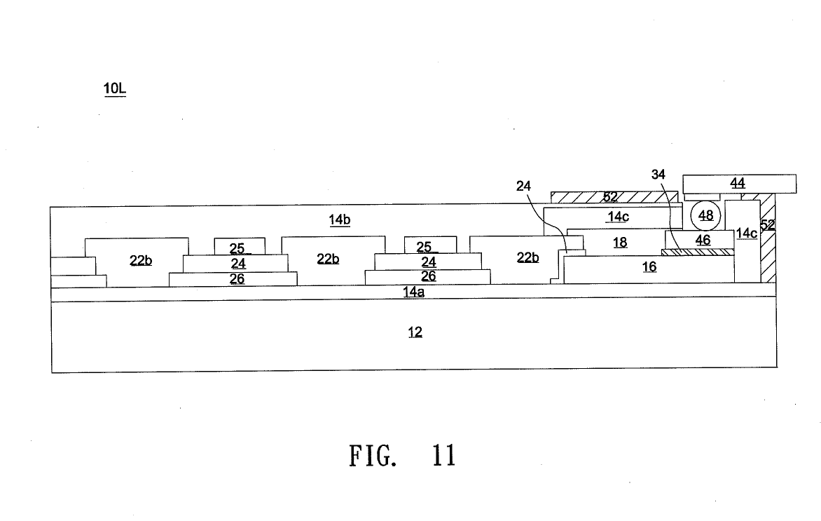

FIG. 11 shows a cross-sectional schematic diagram of a touch-sensitive device 10L according to another embodiment of the invention. In this embodiment, the second insulation layer 14c extends in two directions respectively parallel to and perpendicular to the substrate 12 to surround one side of the decorative layer 16. The first buffer layer 14a is formed on and covers the substrate 12, and the second buffer layer 34 is formed on the decorative layer 16 and spaced apart from the dielectric layer 24. A conductive layer 46 is formed on the second buffer layer 34 and electrically connected to the metal traces in the trace layer 18. In this embodiment, the second buffer layer 34 may occupy a region overlapping the conductive layer 46 and substantially equal to or slightly larger than an area of the conductive layer 46. The conductive layer 46 may be made from an ITO transparent conductive film or an metal layer. An opening is formed on the second insulation layer 14c at a position overlapping a bonding area of the conductive layer 46 to expose a part of the conductive layer 46. The exposed part of the conductive layer 46 is electrically connected to an external circuit through an anisotropic conductive film (ACF) 48, and the external circuit may be a transmission device (such as a flexible printed circuit board 44) or an electronic device (such as an IC chip). The conductive layer 46 is not limited to be formed on the second buffer layer 34. For example, in case the second buffer layer 34 is not provided as shown in FIG. 5, the conductive layer 46 may be formed on the decorative layer 16. Besides, an ink layer 52 is disposed on the periphery of the touch-sensitive device 10f to surround the decorative layer 16 on the second insulation layer 14c to provide periphery protection of the wiring structure on the cover lens and avoid peripheral light leakage.

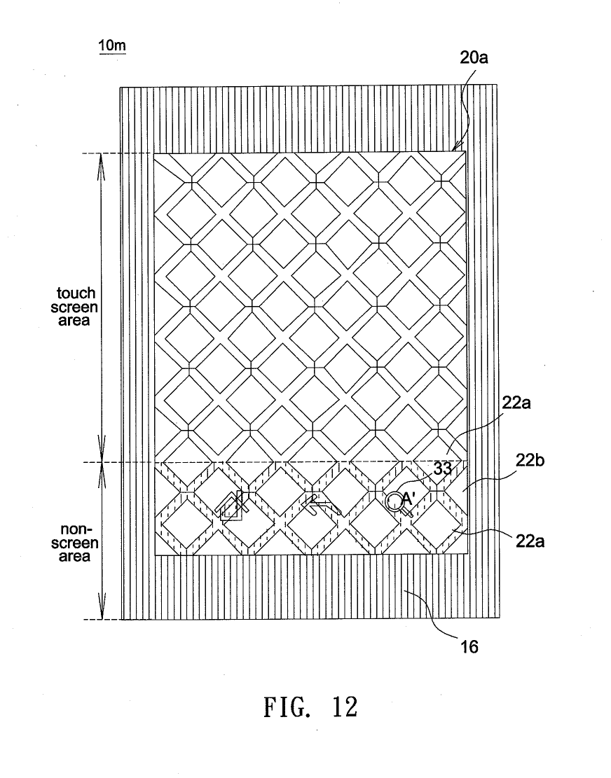

As shown in FIG. 12, a touch-sensitive device 10m has a touch screen area and a non screen area. The decorative layer is disposed in the non-screen area, the touch-sensing structure 20a is substantially disposed in the touch screen area, but a part of the touch-sensing structure 20a extends to spread over the non screen area. For example, at least one of part of the first sensing unit and part of the second sensing unit of the touch-sensing structure 20a may extend to the non-screen area. Further, at least one pattern 33 is formed on a part of the non-screen area overlapping the touch-sensing structure 20a. The pattern 33 may be carved on a decorative layer 16 and may have restricted light-transmittance to be barely visible when a touch-sensitive device is not turned on. Certainly, in an alternate embodiment, the decorative layer 16 may be hollowed out to carve a clearly visible pattern 33 on a touch-sensitive device that is not turned on, and the pattern 33 may be provided with a specific color by, for example, coating a color layer on or adhering a color film to the decorative layer 20g. In addition, the pattern 33 is not limited to the type shown in FIG. 12. The type of the pattern 33 may be, but is not limited to, a text (such as a letter, trademark, logo or Arabic number) or a symbol (such as an icon, graphics, geometric conformation or a hole).

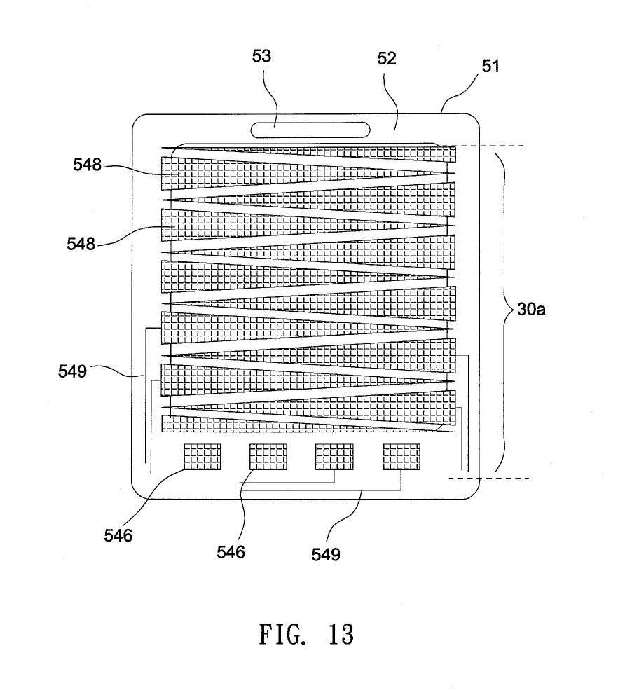

Further, the touch-sensing structure may be formed by patterning a single-layered electrode layer. For example, as shown in FIG. 13, the touch-sensing structure 30a mainly includes button-type single-layered electrodes 546 and triangle-type single-layered electrodes 548. Certainly, the single-layered electrode layer includes but is not limited to the button-type single-layered electrodes 546 and the triangle-type single-layered electrodes 548. The button-type single-layered electrodes 546 or the triangle-type single-layered electrodes 548 may form a transparent electrode pattern occupying an entire plane or form a mesh-wire pattern shown in FIG. 13. Conductive traces 549 are formed on the decorative layer 52, and the conductive traces 545 may be metallic or transparent. Note only a part of the conductive traces 549 is illustrated in FIG. 13, and the other parts of the conductive traces 545 are omitted. At least one hole 53 is formed on the decorative layer 52 above the cover lens 51. In this embodiment, a media layer such as the dielectric layer 24 may be similarly disposed between a part of the single-layered electrodes 546 or 548 and the decorative layer 52 to shield the decorative layer 52 and prevent the transparent conductive material from being left on the decorative layer 52.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A touch-sensitive device, comprising:
a substrate;
a decorative layer disposed on the substrate;
a touch-sensing structure disposed on the substrate, wherein a part of the touch-sensing structure overlaps the decorative layer;
a media layer disposed at least between the part of the touch-sensing structure and the decorative layer; and
an insulation layer disposed on the substrate and covering the touch-sensing structure.

2. The touch-sensitive device as claimed in claim 1, wherein the decorative layer disposed at least on a periphery of the substrate.

3. The touch-sensitive device as claimed in claim 1, wherein the insulation layer is made from an inorganic material or an organic material.

4. The touch-sensitive device as claimed in claim 1, further comprising:
a trace layer disposed on the substrate and overlapping the decorative layer, wherein the trace layer is electrically connected to the touch-sensing structure.

5. The touch-sensitive device as claimed in claim 4, further comprising:
a first buffer layer formed on the substrate and covering the substrate, wherein the decorative layer is formed on the first buffer layer and the trace layer is formed on the decorative layer.

6. The touch-sensitive device as claimed in claim 4, further comprising:
a second buffer layer formed between the trace layer and the decorative layer.

7. The touch-sensitive device as claimed in claim 4, further comprising:
a conductive layer disposed on the decorative layer and electrically connected to the trace layer and an external circuit.

8. The touch-sensitive device as claimed in claim 1, wherein the media layer is an organic layer or a dielectric layer.

9. The touch-sensitive device as claimed in claim 1, wherein the touch-sensing structure comprises a plurality of first sensing unit and a plurality of second sensing unit.

10. The touch-sensitive device as claimed in claim 9, wherein at least one of a part of the first sensing unit and a part of the second sensing unit is formed on the decorative layer.

11. The touch-sensitive device as claimed in claim 1, wherein the touch-sensitive device has a touch screen area and a non-screen area, the decorative layer is disposed in the non-screen area, the touch-sensing structure is substantially disposed in the touch screen area, and a part of the touch-sensing structure extends to spread over the non-screen area.

12. The touch-sensitive device as claimed in claim 1, wherein the decorative layer is carved out to form at least one of a symbol and a text.

13. The touch-sensitive device as claimed in claim 1, wherein the substrate is a glass substrate or a plastic substrate.

14. A touch-sensitive device, comprising:
a substrate;
a decorative layer disposed on the substrate;
a touch-sensing structure disposed on the substrate, wherein a part of the touch-sensing structure spreads over the decorative layer;
a trace layer disposed on the substrate and overlapping the decorative layer, wherein the trace layer is electrically connected to the touch-sensing structure; and
an insulation layer disposed on the substrate and covering the touch-sensing structure and the trace layer.

15. The touch-sensitive device as claimed in claim 14, further comprising:
a media layer disposed at least between the part of the touch-sensing structure and the decorative layer.

16. The touch-sensitive device as claimed in claim 14, wherein the touch-sensing structure comprises a plurality of first sensing unit and a plurality of second sensing unit.

17. The touch-sensitive device as claimed in claim 14, wherein the insulation layer is made from an inorganic material or an organic material.

18. The touch-sensitive device as claimed in claim 14, wherein the decorative layer is carved out to form at least one of a symbol and a text.

19. The touch-sensitive device as claimed in claim 14, further comprising:
a buffer layer formed on the decorative layer; and
a conductive layer formed on the buffer layer, wherein the buffer layer occupies a region substantially equal to or slightly larger than an area of the conductive layer.

20. A touch-sensitive device, comprising:
a substrate;
a decorative layer disposed on the substrate;
a touch-sensing structure disposed on the substrate;
a trace layer disposed on the substrate and overlapping the decorative layer, wherein the trace layer is electrically connected to the touch-sensing structure; and
a buffer layer formed on the decorative layer; and
a conductive layer formed on the buffer layer and electrically connected to the trace layer, wherein the buffer layer occupies a region overlapping the conductive layer.

21. The touch-sensitive device as claimed in claim 19, wherein the buffer layer is made from an inorganic material or an organic material.

22. A touch sensitive display device having an active display area and a non-active area and comprising:
a touch-sensitive device, comprising:
a substrate;
a decorative layer disposed on the substrate;
a touch-sensing structure disposed on the substrate, wherein a part of the touch-sensing structure spreads over the decorative layer; and
an insulation layer disposed on the substrate and covering the touch-sensing structure; and
a display device disposed on one side of the touch-sensitive device.
